(19) United States
(12) Patent Application Publication
(10) Pub. No.: US 2024/0159509 A1
(43) Pub. Date: May 16, 2024

(54) MEASUREMENT DEVICE FOR MEASURING A MEASUREMENT VALUE ON AN OBJECT SURFACE AND MEASUREMENT SYSTEM HAVING SUCH A MEASUREMENT DEVICE

(71) Applicant: Carl Mahr Holding GmbH, Goettingen (DE)

(72) Inventor: Clemens SULZ, Großweikersdorf (AT)

(21) Appl. No.: 18/506,406

(22) Filed: Nov. 10, 2023

(30) Foreign Application Priority Data
Nov. 11, 2022 (DE) 10 2022 129 843.4

(51) Int. Cl. G01B 5/28; G01B 21/04

(52) U.S. Cl. CPC G01B 5/28; G01B 21/042

(57) ABSTRACT

A measurement device and a measurement system comprising a measurement device and a machine tool are disclosed. The measurement device has a support with a connection body arranged thereon as an interface to a machine side holding device of the machine tool. A measurement unit is arranged on the support including a probe tip, a linear drive unit for movement of the probe tip in a movement direction, a sensor unit for detection of the position of the probe tip in a probing direction, and a measurement control unit communicatively connected with the linear drive unit and the sensor unit. The measurement unit preferably comprises an electrical energy supply, such as a battery. The measurement control unit is configured for wireless communication with a machine control device of the machine tool. Accordingly, the measurement control unit and the machine control device can cooperate to control the measurement progress.

### CROSS REFERENCE TO RELATED APPLICATION

This application claims the benefit of German Patent Application No. 10 2022 129 843.4, filed Nov. 11, 2022, which is incorporated herein by reference in its entirety.

### TECHNICAL FIELD

The invention refers to a measurement device for measuring a measurement value on an object surface of an object, wherein the measurement device is configured for use in a conventional machine tool. The invention refers in addition to a measurement system comprising a measurement device as well as an additional control, wherein the measurement system is configured for use in a machine tool, for example.

### BACKGROUND

The measurement device according to the invention is particularly configured to measure a measurement value describing the roughness of the object surface.

Roughness measurement apparatus are known. For example, the company Mahr GmbH offers roughness measurement apparatus, such as the apparatus MarSurf SD26. The roughness measurement apparatus has a probe arm provided with a magnetic holder that is arranged on a probe arm holder of a forward feed apparatus. By means of the forward feed apparatus, the probe arm can be moved linearly. On the probe arm a probe tip is arranged by means of which roughness measurement values can be measured.

The roughness measurement device having a reference standard is described in DE 103 34 219 B3. The reference standard is thereby integrated in a holding device for a forward feed apparatus and arranged within the reach of the probe tip of the probe arm.

The company Blum-Novotest GmbH offers a roughness measurement apparatus TC 63-RG Single, which allows a machine-integrated quality monitoring of straight surfaces. The roughness measurement apparatus has a wireless interface for transmission of detected measurement values.

Additional roughness measurement apparatus are known from the following documents, for example: DD 204 542 A1, DE 10 2005 035 786 B3, DE 10 2017 105 814 B3, DE 20 2014 101 900 U1, WO 2015/036299 A1 or WO 2018/150178 A1.

EP 3 229 088 B1 describes a method for monitoring the machine geometry of a tooth machining machine as well as a measurement device and a suitable software module for this purpose.

Known from EP 1 627 203 B1 is a method for measurement value detection on a workpiece by means of a coordinate measurement apparatus. A deflection of a probe pin is detected by a probe head and is transformed into a coordinate system of the coordinate measurement apparatus. Thereby a probe tip deflection is considered that occurs tangentially to the workpiece surface.

DE 10 2018 109 880 A1 discloses a sensor module for a machine tool that can detect system and operation conditions during machining of a workpiece and can transmit them to an evaluation unit.

A method for spatial measurement of objects by means of a measurement probe is described in DE 10 2007 020 172 A1. At multiple calibration points at least one correction value can be determined using a calibration body and can be used for the correction of measurement values. A measurement device having an optical or interferometrical measurement principle is known from DE 10 2005 018 239 B3 in which the measurement reliability shall be increased. For this purpose, the measurement device is supported by means of a support rod on an object to be measured or an object carrier.

A method in the system for detection of a workpiece contour and for correction of a setpoint path for the measurement of the workpiece in a machine tool are described in DE 10 2015 006 636 A1. A measurement probe having a probe tip continuously creates output data for this purpose that describe a setpoint-actual-value-deviation of the contour to be produced. These data are transformed in machine coordinates in a control of the machine tool and if applicable, the path is corrected along which the workpiece is machined.

### SUMMARY

It is one object of the present invention to provide a simple measurement device for measurement of a measurement value that particularly describes the roughness of an object surface, which is suitable for use in different machine tools while having a simple configuration and which can particularly use a standard interface of the machine tool.

This object is solved by means of a measurement device and a measurement system comprising a machine tool and a measurement device as described herein.

The measurement device according to the invention is configured for measurement of a measurement value on an object surface of an object. It comprises a support on which a connection body is arranged. The connection body forms an interface to a machine side holding device of a machine tool. For example, the machine side holding device can be a chuck, a revolver or a spindle, where the connection body can be arranged or clamped. The machine side holding device is the interface on the machine tool for arranging a tool or the support by means of the connection body.

The connection body can be part of the support or can be connected with the support and the type of a tool holder. By means of the connection body, the measurement device can be inserted into and removed out of the machine side holding device of the machine tool. The insertion and removal can be carried out manually or automatically, e.g. by means of a robot, a gripper or another manipulator.

For example, the connection body can form a standard interface, such as a steep-angle taper (SK) according to DIN ISO 7388 or a hollow shank taper (HSK) according to DIN 69893.

The machine tool is particularly a processing machine by means of which the shape or geometry of the object or workpiece is processed and modified. For example, the machine tool can be a grinding machine, a milling machine, a laser processing machine, a lathe, a forming machine or an arbitrary combination thereof.

The measurement device has a probe tip that is movably supported in a probing direction. The movement of the probe tip can be a pivot movement comprising a movement component in probing direction or a linear movement in probing direction. In any case, the probe tip can at least carry out a movement having a movement component in probing direction. The probe tip is configured to be brought into contact with the object surface for measurement of a measurement value so that it abuts at a measurement location on the object surface. The measurement value is defined by the position or the position change of the probe tip in probing direction during measurement.

The measurement device comprises a measurement control unit. For detection of a measurement value, the measurement device comprises in addition a sensor unit that is communicatively connected with the measurement control unit. By means of the sensor unit, the position of the probe tip in probing direction is detected, which position is described by means of a sensor value of the sensor unit. The sensor value is provided to the measurement control unit. The sensor value can be further processed in the measurement control unit and/or can be directly transmitted to the machine control device. In the simplest case the sensor value can be used as measurement value. It is, however, also possible to determine or calculate a measurement value from at least one sensor value.

The measurement device comprises in addition a linear drive unit that is configured to move the probe tip linearly in a movement direction during measurement. The movement direction is orientated orthogonal to the movement direction.

The measurement control unit of the measurement device comprises a wireless communication interface that is configured for wireless communication with an additional control. For example, detected measurement values can be transmitted to the additional control in a wireless manner by means of the communication interface.

The probe tip, the assigned sensor unit and the linear drive unit as well as the measurement control unit are directly or indirectly arranged on the support of the measurement device and form a measurement unit. The measurement unit can thus be handled as a whole and can be inserted into and removed from the machine side holding device, e.g. by means of the connection body and the thereby provided interface.

It is particularly advantageous, if the measurement device and particularly the measurement unit comprises in addition a rechargeable battery for energy supply that is preferably indirectly or directly arranged on the support. In doing so, the measurement device can be supplied with electrical energy without supply cable to an energy source. The electrical energy is provided to all of the electrically operated components of the measurement device or the measurement unit, e.g. the linear drive unit, the measurement control unit and the sensor unit.

The measurement device and particularly the measurement unit can comprise an adapter for electrical connection of the battery to a charging device. The adapter can be a non-removable part of the measurement device or the measurement unit and thus can be indirectly or directly arranged on the support. Alternatively, the adapter can also be removably directly or indirectly arranged on the support. The charging device can serve for storing the measurement device, if the measurement device is not used for measurement in the machine tool, e.g. during machining of the object. The charging device can also be assigned to a storage location of the measurement device in a tool magazine and can be, e.g. part of the tool magazine. In the tool magazine also additional storage locations for processing tools of the machine tools can be provided in addition to the measurement device. The adapter can be configured to establish a wired and/or a wireless connection (e.g. inductive connection) between the measurement unit or the battery on one side and the charging device on the other side.

The measurement device and particularly the measurement unit can further comprise a rotary or translational additional drive, in addition to the linear drive unit. By means of the at least one additional drive, the probe tip can be moved linearly or in a rotating or pivoting manner. The probe tip is thereby moved relative to the connection body and/or the support of the measurement device.

For each movement degree of freedom of the probe tip relative to the connection body or the support, a corresponding position sensor can be provided that transmits the respectively detected position value to the measurement control unit.

Preferably one of the optional additional drives can be configured to move the probe tip between multiple of the following positions: a measurement position provided for measurement of the object surface, a rest position remote from the measurement position and a calibration position provided for carrying out a calibration method. One of the optionally provided additional drives can be configured to move the probe tip between the measurement position and the rest position, for example. The probe tip can thus take two or three different positions.

In the optional calibration position the probe tip is assigned to a measurement standard and abuts on the surface of the standard. The standard can be part of the measurement device and can be directly or indirectly arranged on the support, for example. In the calibration position the probe tip can be moved along a surface of the standard in order to carry out a calibration method of the measurement device.

The measurement position and the calibration position can be positions that are different from one another or the measurement position is also the calibration position.

In another advantageous embodiment the measurement device and particularly the measurement unit comprises a protective enclosure in order to protect the measurement device and particularly the probe tip and/or an optionally provided standard from external influences. A protective enclosure can have an opening through which the probe tip can project out of the protective enclosure, at least if the probe tip is in the measurement position. The opening can be opened and closed by means of a cover, which can be moved manually or automatically. Particularly, the measurement device can be configured to block a movement of the probe tip in the measurement position as long as the cover closes the opening.

It is advantageous, if the measurement device and particularly the measurement unit comprise at least one support body or also multiple support bodies arranged with distance to one another. Each present support body is configured to support the measurement device in an operation position of the measurement device adjacent to a measurement location on the object surface. Thereby, for example, the support body can directly abut on the object or an object holder. The at least one support body can be arranged on the support or the protective enclosure or another suitable component of the measurement device. The at least one support body can also be configured to be arranged selectively at multiple different locations on the support, on a housing (e.g. protective enclosure) of the measurement device.

The at least one support body can be elastically deformable. In the operation position the support body, therefore, provides a damping function so that vibrations or oscillations from the object or an object holder are not transmitted to the measurement device or are at least sufficiently damped. The at least one support body is preferably deformed compared to its initial form, if the measurement device is in the operation position. The at least one support body can comprise an elastically deformable ring-shaped (e.g. circular shape or elliptical or oval) element.

An elastically deformable support body here means a support body that can be deformed elastically under the forces normally occurring between the measurement device and the object.

It is preferred, if the measurement device and particularly the measurement unit comprises a position sensor, which is communicatively connected to the measurement control unit. The position sensor is configured to detect reaching of the operation position relative to the object surface or the object and to provide a respective position signal. The position sensor can be a switching sensor or a continuously measuring sensor. For example, the position sensor can create a position signal and provide it to the measurement control unit that characterizes the distance to the object surface and indicates at least the distance defining the operation position.

Alternatively to the detection of the operation position by means of the measurement device, the position monitoring of the measurement device can also be carried out by means of the machine control device and—if required or desired—can be transmitted from the machine control device to the measurement control unit of the measurement device.

The optionally provided position sensor of the measurement device can be assigned to the at least one support body and can, for example, directly or indirectly detect a force acting on the support body. In one embodiment the position sensor can be a strain gauge, by means of which an elastic deformation of the support body can be detected.

The measurement control unit can be configured to transmit reaching of the operation position to the machine control device.

It is advantageous, if the measurement control unit is configured to control one of the optionally provided additional drives after reaching the operation position in order to move the probe tip in the measurement position on the object surface. By means of this additional drive, also the pressing force between the probe tip and the object surface can be controlled in open loop or closed loop manner. For this purpose, a respective force producing unit of the additional drive can be provided that can operate mechanically and/or magnetically and/or electromagnetically.

Alternative to this, it is also possible that the probe tip takes the measurement position automatically when the measurement device reaches the operation position. In this embodiment the additional drive can be avoided, wherein however a force producing unit for adjusting the pressing force between the probe tip and the object surface can be provided, as explained above.

In another advantageous embodiment the measurement device and particularly the measurement unit can comprise a cleaning unit. Alternatively to this, the cleaning unit can also be provided separately from the measurement device and can be part of a measurement system, wherein the measurement device forms part thereof. The cleaning unit is configured to clean the measurement location on the object surface, particularly by creation of a gas flow, e.g. an air flow. For example, the cleaning unit can comprise a fan drivable by an electric motor and/or a fluid nozzle, particularly air nozzle, that is or can be connected to a pressure source. In this case the measurement device comprises a medium interface that establishes a fluid connection to a fluid source when the measurement device is inserted into the machine side holding device of the machine tool, in order to supply the fluid nozzle with cleaning fluid.

It is advantageous, if the arrangement of the fluid nozzle relative to the probe tip or the movable support thereof is configured so that the fluid flow of the fluid nozzle, particularly air flow, counteracts a potential entrance of contaminations, e.g. particles and/or liquids, into the measurement device and particularly the measurement unit in the area of the probe tip.

In an embodiment the measurement unit, particularly the probe tip and its movable support, can be protected by a suitable measure from the fluid flow and from contaminations (e.g. particles and/or liquids) stirred up by and/or carried within the fluid flow, at least during a cleaning phase while cleaning is carried out. For example, an optional measure can be a suitable positioning of the measurement unit and/or the probe tip during a cleaning phase in an area that is not affected by the fluid flow and stirred up or transported contaminations resulting therefrom. Additionally or alternatively, the measurement unit and/or the probe tip can be shielded and/or enclosed and/or encapsulated by means of a protection device during a cleaning phase. For example, a housing part having an opening can be provided surrounding the probe tip and/or its movable support. A controllable movable cover (e.g. flap, slider, shutter, . . . ) of the protection device can be assigned to this opening and can cover the opening in a closing position and can keep the opening open in an open position. In the open position the probe tip can project through the opening for measurement. In the closing position the opening and the probe tip are covered by means of the cover in a manner inaccessible from outside.

It is in addition advantageous, if the measurement device comprises a damping device. By means of the damping device a damping of vibrations and oscillations can be carried out that could be introduced by means of the machine side holding device into the measurement device. The damping device thus serves for decoupling the measurement device from the machine tool. The damping device is particularly arranged in the mechanical connection between the connection body and the probe tip or the linear drive unit. For example, the damping device can be arranged between the connection body and the support or between a first support part and a second support part.

As explained above, the measurement device can be part of a measurement system according to the invention. Thereby the measurement device can be manually or automatically inserted into or removed from the machine side holding device of the machine tool. The machine control device of the machine tool and the measurement control unit of the measurement device can cooperate, due to the wireless communication connection in order to control the measurement progress for measuring the measurement value.

For calibration of the measurement device, a measurement standard can be present that is arranged at a suitable position in the machine tool or is optionally part of the measurement device and particularly the measurement unit, as it has already been explained above. Preferably, the standard is a roughness standard.

In an embodiment the standard can be releasably attached in an operation area of the machine tool. The operation area of the machine tool is an area that can be reached by a tool arranged in the machine side holding device or that can be reached by a measurement device arranged in the machine side holding device during movement of the machine side holding device relative to a machine basis. The standard can be protectively arranged in this operation area, e.g. in a chamber that can be opened and closed relative to the remaining operation area in order to protect the standard from influences during machining of an object or workpiece. For example, the standard can be releasably attachable by means of a magnetic attachment device or in another manner in or on the machine tool.

### BRIEF DESCRIPTION OF THE DRAWINGS

Additional advantageous embodiments of the invention are derived from the dependent claims, the description and the drawing. In the following, preferred embodiments of the invention are explained in detail based on the attached drawings. The drawings show:

FIG. 1 a schematic block-diagram-like illustration of an embodiment of a measurement device,

FIG. 2 a schematic block-diagram-like illustration of an embodiment of a measurement system comprising a machine tool and a measurement device according to FIG. 1,

FIGS. 3 and 4 a schematic principle illustration of an embodiment of the measurement device respectively having an additional drive in order to be able to move the probe tip of the measurement device between multiple positions, wherein the connection body of the measurement device is not illustrated,

FIG. 5 a block diagram showing a measurement control unit of the measurement device as well as a machine control device of the machine tool,

FIG. 6 a schematic illustration of an embodiment of a measurement device having a protective enclosure as well as a cleaning unit and

FIG. 7 an embodiment of a measurement device comprising a damping device and

FIG. 8 a flow diagram of an embodiment of a method for measurement of an object using the measurement device in a machine tool.

### DETAILED DESCRIPTION OF THE DRAWINGS

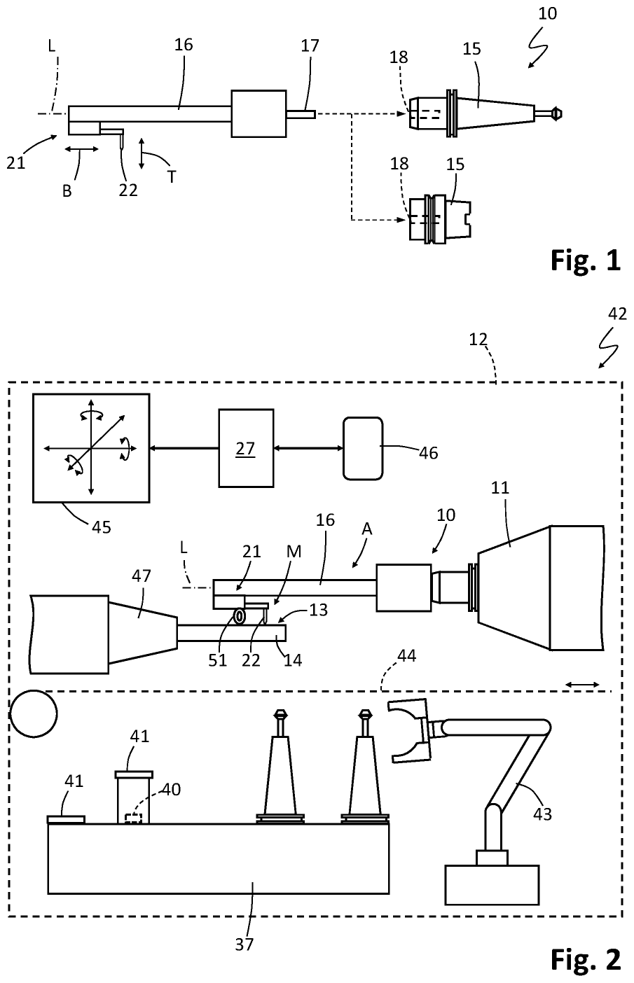

FIG. 1 is a schematic illustration of an embodiment of a measurement device 10. The measurement device 10 is configured to be arranged in a machine side holding device 11 of a machine tool 12 by means of a defined interface (FIG. 2). As also apparent from FIG. 2, the measurement device 10 is configured for measurement of a measurement value on an object surface 13 of an object 14. For example, measurement values can describe the roughness of the object surface 13.

The measurement device 10 comprises a connection body 15 as interface to the machine side holding device 11. For example, the connection body 15 can comprise or be a hollow shank taper (HSK) or a short taper (SK). The connection body 15 is non-releasably or releasably connected with a support 16 of the measurement device 10. The connection body 15 can be provided on a tool holder at which the support 16 can be releasably attached, for example. In the embodiment the support 16 comprises a connection device 17 (e.g. a connection pin), which can be releasably mounted on a mounting device 18 (e.g. mounting recess) on the connection body 15, e.g. by means of a form-fit and/or force-fit connection. For example, the connection pin can be inserted into the mounting recess and can be fixated there, particularly using a securing screw. Thus, also multiple different connection bodies 15 can be releasably connected to the support 16 in order to adapt measurement device 10 to the configuration of the machine side holding device 11.

A measurement unit 21 is seated on support 16. A probe tip 22, which is movable in a probing direction T, a linear drive unit 23, a measurement control unit 24 as well as a sensor unit 25 are part of the measurement unit (FIG. 5). The named units 23, 24, 25 can be arranged in a housing of the measurement unit 21.

The movable support of the probe tip 22 in probing direction T can be configured so that the probe tip 22 is linearly movable in probing direction T. The movement in probing direction T can, however, also be only a movement component of the movable probe tip 22, that can be, for example pivotably supported around an axis orientated orthogonal to the probing direction.

By means of the linear drive unit 23, probe tip 22 can be linearly moved in a movement direction B. The movement direction B is orientated orthogonal to the probing direction T and extends, according to the example, parallel to a longitudinal axis L. The support 16 extends from its end assigned to the connection body 15 along the longitudinal axis L up to its free end on which the measurement unit 21 is arranged.

According to the example, probe tip 22 is configured to establish a point-shaped or as far as possible point-shaped contact with the object surface 13, if the probe tip 22 is in a measurement position M (FIGS. 2, 3 and 7). Particularly, measurement unit 21 comprises no other probing elements in addition to the probe tip 22, such as a skid or the like, that move together with probe tip 22 in movement direction B during measurement.

The sensor unit 25 and the measurement control unit 24 are communicatively connected. The sensor unit 25 is configured to create a sensor value W and to provide it to the measurement control unit 24, whereby the sensor value W describes the position or position change of probe tip 22 in probing direction T.

The measurement control unit 24 is configured for indirect or direct communication with a control 28. For this purpose, measurement control unit 24 has a communication interface 26, which is configured for wireless communication in the embodiment. The control 28 can be part of a machine control device 27 or can be configured for wireless and/or wired communication with the machine control device 27. According to the example, control 28 also comprises a communication interface 26 configured for wireless communication. Via communication interfaces 26 the measurement control unit 24 and control 28 can communicate with one another in a wireless manner. The communication corresponds preferably to a standardized communication protocol, e.g. to the “Bluetooth” standard or to the “Bluetooth Low Energy” standard. Also any other communication protocol can be used that is configured for wireless communication. Via an additional communication connection control 28 and machine control device 27 can communicate with one another in the embodiment. The control 28 can be configured to receive and optionally process measurement values from the measurement control unit 24. The control 28 can optionally also be configured to transmit evaluation information and/or control information to the machine control device 27 based on the received and/or processed measurement values.

As further apparent from FIG. 5, measurement unit 21 can in addition comprise a rechargeable battery 30 for energy supply of the measurement unit 21. By means of the battery 30, particularly the measurement control unit 24, the linear drive unit 23 and the sensor unit 25 can be either indirectly or directly supplied with electrical energy. Preferably battery 30 supplies all of the electrically operated units and components of the measurement unit 21 arranged on support 16 with the required electrical energy.

An adapter 31, which is accessible from outside and which has electrical contacts 32, can be provided on the battery 30 or at another suitable position of the measurement unit 21. By means of the adapter 31 an electrical connection with a non-illustrated charging device can be established, e.g. if measurement device 10 is stored in a tool magazine 37 of machine tool 12. If measurement device 10 is not needed, battery 30 can be charged with electrical energy by means of the charging device. An electrical connection to the charging device can be established via the electrical contacts 32.

In modification to the adapter 31 schematically illustrated in FIG. 5, the measurement unit 21 and/or the adapter 31 can additionally or alternatively comprise an interface for inductive charging of battery 30.

The adapter 31 can be a removable or non-removable part of measurement unit 21.

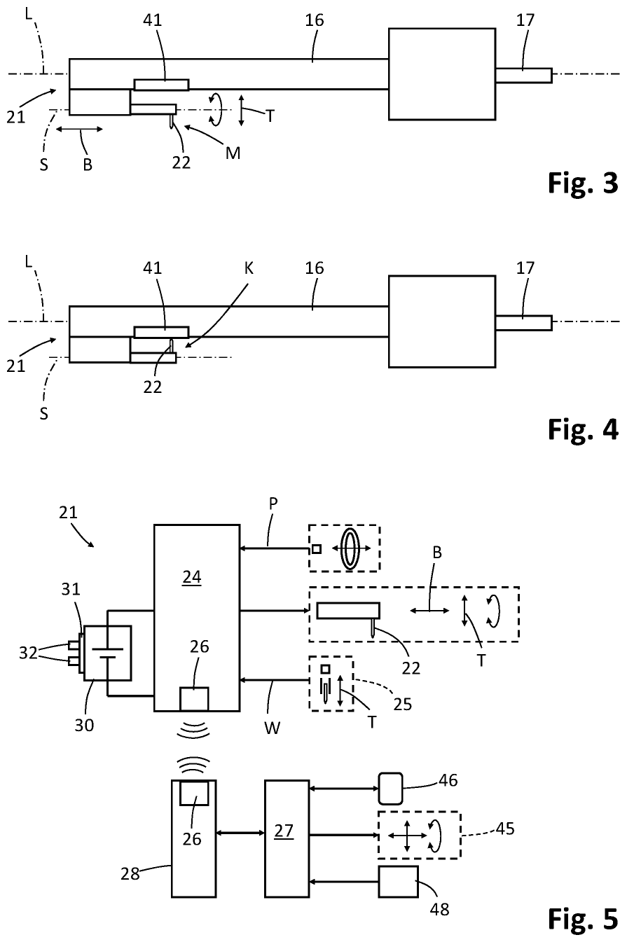

Based on FIGS. 3-5 it is schematically illustrated that the measurement unit 21 can comprise at least one additional drive 33 in addition to the linear drive unit 23. The at least one additional drive 33 can be configured to move probe tip 22 in addition to the linear movement in movement direction B in at least one additional translational and/or rotary degree of freedom, e.g. in probing direction T and/or around a pivot axis S that is orientated parallel to movement direction B. The number of optionally provided additional drives 33 is arbitrary. For example, up to two linear additional drives 33 and up to three rotary additional drives 33 can be present, for example.

In the embodiments schematically illustrated in FIGS. 3, 4 and 5, one linear additional drive 33 as well as one rotary additional drive 33 are provided respectively, so that probe tip 22 can be pivoted around the pivot axis S and can be linearly moved in probing direction T. The additional drive 33 for moving the probe tip 22 in probing direction T can concurrently serve as force producing unit in order to adjust a pressing force between probe tip 22 and object surface 13. If such an additional drive 33 is not provided, the force producing unit can also be configured separately. The force producing unit can operate mechanically, magnetically or electromagnetically in order to create the pressing force.

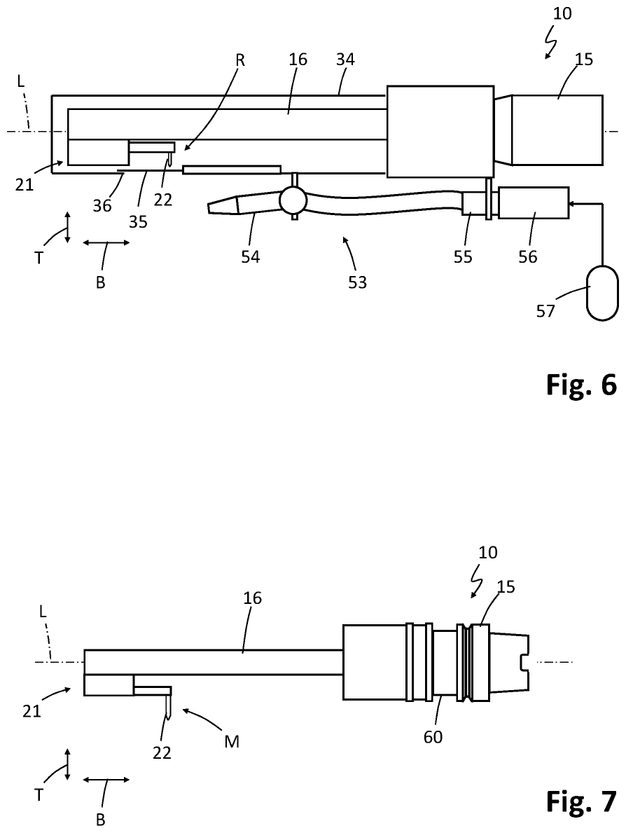

In embodiments that have at least one additional drive 33, probe tip 22 can be moved between at least two of the following positions: the measurement position M, a rest position R (FIG. 6) and a calibration position K. In these additional positions probe tip 22 is not configured to abut against the object surface 13. For example, in the rest position R probe tip 22 can be arranged inside an optionally provided protective enclosure 34 of measurement device 10 and can be located particularly entirely inside the interior of protective enclosure 34 in the rest position R (FIG. 6). The protective enclosure 34 can have an opening 36 adjacent to the measurement unit 21 or the probe tip 22 that can be closed by means of a cover 35. The cover 35 can be moved between an open position and a closing position either manually or automatically. In the closing position it covers the opening 36 so that the interior of the protective enclosure 34 is not accessible. The closing position is illustrated in FIG. 6. In the open position cover 35 uncovers opening 36 so that probe tip 22 can be moved out of its rest position R into the measurement position M in which it extends through the opening 36 outwardly.

FIGS. 3 and 4 show an embodiment of the measurement device 10 in which a measurement standard 41 is arranged on support 16. The standard 41 is a roughness standard according to the example. In the calibration position K (FIG. 4) probe tip 22 abuts on the standard 41 and can be moved by means of the linear drive unit 23 in movement direction B along the surface of standard 41. In this manner the measurement device 10 can be calibrated.

Alternatively, standard 41 can be arranged outside of measurement device 10 and can be part of the measurement system 42 illustrated schematically in FIG. 2, which comprises the measurement device 10 according to the invention as well as the machine tool 12. The standard 41 can be arranged by means of an attachment device 40, e.g. an attachment magnet, at a suitable position in the operation area of machine tool 12, so that it can be reached by probe tip 22 for carrying out the calibration. The movement between the standard 41 and the measurement device 10 is carried out particularly exclusively by means of the machine side holding device 11 of machine tool 12. In addition or as an alternative, also a machine axis could be provided for movement of the standard 41 relative to the machine basis or to the machine side holding device 11. Additionally or alternatively, the standard 41 could also be non-releasably attached in the operation area of the machine tool 12, e.g. on the tool magazine 37.

For inserting or removing the measurement device 10 in the machine side holding device 11, measurement system 42 or machine tool 12 can comprise a manipulator 43, e.g. a robot arm having a gripping device. As an option, the standard 41 can be positioned at a suitable position in the operation area of the machine tool 12 or in the movement range of the machine side holding device 11 by means of the manipulator 43. For example, the standard 41 can be taken out of the tool magazine 37 for calibration and can be placed at a suitable position and can be restored in the tool magazine 37 after termination of the calibration process. The standard 41 and/or the entire tool magazine 37 can be protected in a separate chamber and/or within the working space by means of a partition 44 in order to avoid damages and/or contamination of standard 41 or of tools stored in the tool magazine 37 during machining of an object 14. For tool exchange or in order to reach the standard 41 arranged in the tool magazine 37 by means of the machine side holding device 11 and the inserted measurement device 10, the partition 44 can be opened.

In FIGS. 2 and 5 it is also apparent that machine tool 12 comprises one or more machine axes 45, an operator interface 46 and an object holder 47. The number and the configuration of the machine axes 45 as well as the object holder 47 depends on the configuration of the machine tool 12. For example, object holder 47 can be a chuck for a rod-shaped and/or rotationally symmetric object 14.

By means of the at least one machine axis 45, the machine side holding device 11 and/or the object holder 47 can be moved relative to one another or relative to a machine basis. Thereby, a machine axis 45 can be configured as linear machine axis or as rotary machine axis, as schematically symbolized in FIGS. 2 and 5 by means of straight arrows or arc-shaped arrows. Up to three linear machine axes and up to three rotary machine axes can be present. The position of the respective machine axis 45 can be detected by means of a sensor of a sensor unit 48 and can be transmitted to the machine control device 27 (FIG. 5).

The measurement device 10 can have a support body 51 (FIGS. 2 and 5). The support body 51 can be indirectly or directly arranged on the support 16, e.g. on a housing of measurement unit 21. Preferably it is located in the proximity of the measurement location on the object surface 13 and thus adjacent to probe tip 22, if the latter takes the measurement position M. The support body 51 is configured to abut against object surface 13 and/or object holder 47, if measurement device 10 is in an operation position A. The operation position A is schematically illustrated in FIG. 2. By means of support body 51, the stability of the relative position between measurement device 10 and the object 14 to be measured is improved. This can be particularly advantageous, if due to the configuration of the machine tool 12 also during measurement, a motorized activation of the at least one machine axis 45 is carried out in order to maintain the relative position and relative orientation between the machine side holding device 11 and the object holder 47. This active control of the at least one machine axis 45 can result in minimum oscillations, vibrations or movements that can be supported or damped by means of the support body 51.

For this purpose, the support body 51 is configured as elastically deformable support body in the embodiment. With the forces normally acting on the support body 51 in the operation position A, the support body 51 is elastically deformed or deformable. For example, it can be ring-shaped having a circular-shaped, elliptical or oval contour in its non-deformed initial condition.

In modification to the illustrated embodiment it is also possible to arrange multiple support bodies 51 at different positions of measurement device 10 and particularly the housing of measurement unit 21 and/or support 16.

The measurement unit 21 of measurement device 10 can have a position sensor 52 that is communicatively connected to the measurement control unit 24 (FIG. 5). The position sensor 52 provides a position signal P for the measurement control unit 24. According to the example, position signal P indicates at least reaching the operation position A. In addition, position signal P can also detect other positions relative to object 14 and create a position signal P indicating these relative positions. For this purpose, position sensor 52 can be configured as distance sensor, for example.

In the embodiment illustrated here, position sensor 52 is assigned to support body 51 and detects a force acting on the support body 51 in the measurement position M. For example, position sensor 52 can determine a deformation of support body 51 in the operation position A of measurement device 10 and thereby indirectly indicate the distance between measurement device 10 and object surface 13. For example, position sensor 52 can be configured as strain gauge arranged on support body 51.

Upon reaching operation position A, probe tip 22 can be automatically in the measurement position M and can be pressed against object surface 13 with the required pressing force. For this purpose, measurement unit 21 can comprise a force creation unit—as explained above. Alternatively to this, upon reaching operation position A of measurement device 10, it is also possible to move probe tip 22 into the measurement position M by means of an optionally provided additional drive 33 (linear movement or pivot movement).

A further configuration option of measurement device 10 is illustrated in FIG. 6 by way of example. In this embodiment measurement device 10 comprises in addition a cleaning unit 53. The cleaning unit 53 is configured to clean the measurement location on the object surface 13 prior to measurement, particularly before probe tip 22 is moved into measurement position M. The cleaning unit 53 can comprise a fluid nozzle 54, for example, which is indirectly or directly arranged on support 16 (according to the example on the protective enclosure 34). By means of the fluid nozzle 54, a fluid, particularly a gas and for example air, can be ejected onto object surface 13 and there the measurement location can be cleaned from contamination particles. For this purpose, fluid nozzle 54 is fluidically connected to a fluid connection 55. The fluid connection 55 is indirectly or directly arranged on support 16 and is positioned so that a fluid connection with a machine side connection 56 is established when measurement device 10 is arranged in the machine side holding device 11. The machine side connection 56 is connected or can be connected with a fluid source 57 in order to eject the cleaning fluid by mean of the fluid nozzle 54 onto the object surface 13 with the connection being established. The fluid can be particularly compressed air.

In addition or as an alternative, the cleaning unit can also comprise a fan that can be driven by means of an electric motor. The fan can be part of the measurement device 10 or alternatively the measurement system 42. For example, the fan can be insertable in the machine side holding device 11. If the machine side holding device 11 is configured as spindle, for example, and can be rotatingly driven around a rotation axis instead of an entire fan, also only a blade arrangement can be inserted in the machine side holding device 11 for producing an air flow.

The ejection of the fluid and/or the creation of an air flow can be controlled by means of the measurement control unit 24 and/or the machine control device 27, e.g. by using one or more controllable valves in the fluid path between the fluid source 57 and the fluid nozzle 54 or by using a controllable drive, for example of the fan.

In FIG. 7 an embodiment of the measurement device 10 is illustrated in which a damping device 60 is additionally present. The damping device 60 is arranged between the connection body 15 and the measurement unit 21 and serves to eliminate or at least reduce oscillations and/or vibrations transmitted from the machine tool 12 or the machine side holding device 11 to the connection body 15. Thus, measurement unit 21 is decoupled from connection body 15 by means of damping device 60. The damping device 60 can for this purpose comprise an elastically deformable body, for example.

The embodiments described above can be arbitrarily combined with each other. For example, all of the embodiments of the measurement unit can comprise a standard 41 (FIGS. 3 and 4) and/or at least one support body 51 (FIG. 2) and/or a cleaning unit 53 (FIG. 6) and/or a damping device 60 (FIG. 7). The measurement system 42 according to FIG. 2 can comprise any embodiment of the measurement device 10.

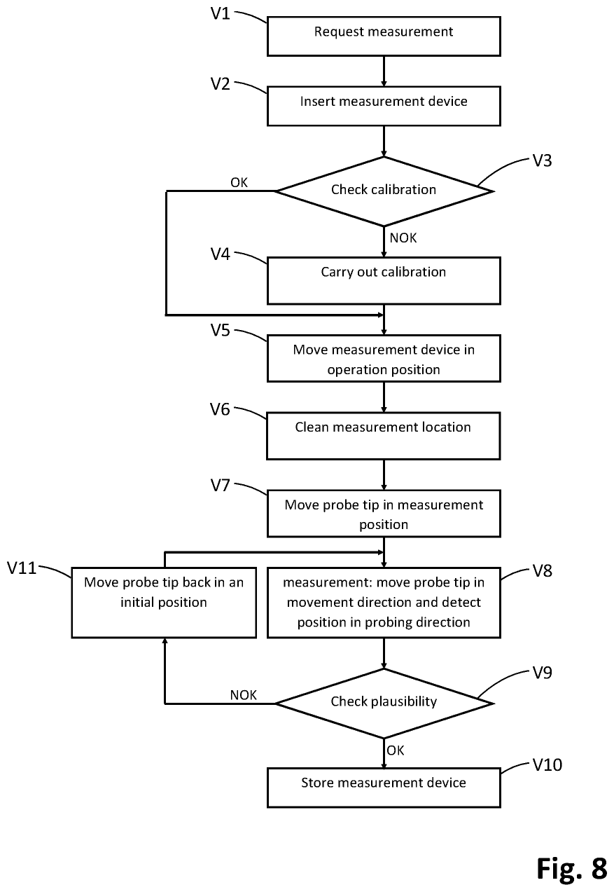

The measurement device 10 is used for carrying out a measurement, as explained in the following based on the flow diagram according to FIG. 8 by way of example:

In a first step V1 the execution of a measurement is requested. This request can be triggered by a measurement program of the machine tool 12 by means of the machine control device 27 and/or by an operating person by means of the operator interface 46. After the request a measurement the measurement device 10 is arranged in the machine side holding device 11 in a second step V2. This can be carried out automatically, for example, in that the machine side holding device 11 and the tool magazine 37 are positioned relative to one another so that the measurement device 10 can be directly removed from the tool magazine 37 by the machine side holding device 11. Alternatively, it is also possible to remove the measurement device 10 from the tool magazine 37 by means of a manipulator 43 and to insert it in the machine side holding device 11. If applicable, prior to this a tool present in the machine side holding device 11 has to be removed and stored in the tool magazine 37 first.

In a third step V3 it is checked whether a valid calibration exists and if not (branch NOK from third step V3), the measurement device is calibrated in an additional fourth step V4. Otherwise (branch OK from third step V3), the method can be directly continued in a fifth step V5.

In the fifth step V5 the measurement device 10 is subsequently moved in operation position A adjacent to the object 14. As soon as the operation position A is reached, the probe tip 22 can either be already in the measurement position M or it is subsequently moved in the measurement position M by means of an optionally provided additional drive 33 (optional seventh step V7).

In a further optional cleaning step the measurement position can be cleaned prior to positioning the probe tip 22 in the measurement position M, whereby the cleaning step is illustrated in the embodiment as a sixth step V6, however, it could temporarily also be carried out prior to the fifth step V5.

Following this, the measurement is carried out in an eighth step V8. For this, linear drive unit 23 is controlled in order to move the probe tip 22 in movement direction B along the object surface 13 while the sensor unit 25 detects a sensor value W describing the position of probe tip 22 in probing direction T. From multiple sensor values W a roughness value can be determined subsequently in the measurement control unit 24 or the machine control device 27 and can be output via the operator interface 46, for example.

Optionally, in a ninth step V9 the plausibility of the measurement can be checked. For example, for this purpose the temporal progress of the sensor values W can be checked, e.g. with regard to a variation frequency of the sensor value W (e.g. variation frequency, temporal gradient, maximum value, minimum value, etc.). Such a plausibility check in the ninth step V9 is, for example possible, if a priori knowledge exists about the object 14 or the object surface 13.

Based on a test or calibration measurement the plausibility check in the ninth step V9 can alternatively or additionally check whether measurement unit 21 still measures correctly or not. An incorrect measurement can result from a probe tip damage, for example, that could have been caused by the movement into the measurement position. The plausibility check by a test or calibration measurement does not require a priori knowledge about the object.

If the optional plausibility check in the ninth step V9 results in the measurement being plausible (branch OK from ninth step V9), the measurement method can be terminated and the measurement device 10 can be stored in the tool magazine 37 again. Otherwise (branch NOK from ninth step V9), probe tip 22 can be moved back in an initial position (eleventh step V11). Subsequently, a measurement can be carried out again in the eighth step V8. It is possible to stop the measurement method, if also after a predefined number of measurements no plausible measurement results can be achieved. Then an error message can be output via operator interface 46.

The invention refers to a measurement device 10 as well as a measurement system 42 comprising a measurement device 10 and a machine tool 12. The measurement device 10 has a support 16 and arranged on the support a connection body 15 as interface to a machine side holding device 11 of the machine tool 12. A measurement unit 21 is arranged on the support 16 comprising a probe tip 22, a linear drive unit 23 for movement of the probe tip 22 in a movement direction B, a sensor unit 25 for detection of the position of the probe tip 22 in a probing direction T as well as a measurement control unit 24 communicatively connected with the linear drive unit 23 and the sensor unit 25. The measurement unit 21 preferably comprises in addition an own electrical energy supply, particularly an battery 30. The measurement control unit 24 is configured for wireless communication with a machine control device 27 of the machine tool. In this manner the measurement control unit 24 and the machine control device 27 can cooperate in order to control the measurement progress.

### LIST OF REFERENCE SIGNS

10 measurement device
11 machine side holding device
12 machine tool
13 object surface
14 object
15 connection body
16 support
17 connection device
18 mounting device
21 measurement unit
22 probe tip
23 linear drive device
24 measurement control unit
25 sensor unit
26 communication interface
27 machine control device
28 control
30 battery
31 adapter
32 electrical contact
33 additional drive
34 protective enclosure
35 cover
36 opening
37 tool magazine
40 attachment device
41 measurement standard
42 measurement system
43 manipulator
44 partition
45 machine axis
46 operator interface
47 object holder
51 support body
52 position sensor
53 cleaning unit
54 fluid nozzle
55 fluid connection
56 machine side connection
57 fluid source
60 damping device
A operation position
B movement direction
K calibration position
L longitudinal axis
M measurement position
P position signal
Et rest position
S pivot axis
T probing direction
V1 first step
V2 second step
V3 third step
V4 fourth step
V5 fifth step
V6 sixth step
V7 seventh step
V8 eighth step
V9 ninth step
V10 tenth step
V11 eleventh step
W sensor value

1. A measurement device (10) for measurement of a measurement value on an object surface (13) of an object (14), comprising:
a connection body (15) that is arranged on a support (16) and that is configured to be exchangeably arranged in a machine side holder (11) of a machine tool (12),
a probe tip (22) that is movably supported in a probing direction (T) and that is configured to be brought into contact with the object surface (13),
a linear drive unit (23) that is configured to linearly move the probe tip (22) during measurement in a movement direction (B) oriented orthogonally with respect to the probing direction (T),
a measurement control unit (24) comprising a wireless communication interface (26) that is configured to establish a wireless communication connection with a machine controller (27), and
a sensor unit (25) that is communicatively connected with the measurement control unit (24) and that is configured to detect a sensor value (W) describing a position of the probe tip (22) in the probing direction (T) and to provide the sensor value to the measurement control unit (24).

2. The measurement device according to claim 1, further comprising a rechargeable battery (30) for energy supply of the measurement device (10).

3. The measurement device according to claim 2, further comprising an adapter (31) for electrical connection of the rechargeable battery (30) with a charging device.

4. The measurement device according to claim 1, further comprising at least one additional drive (33) configured to move the probe tip (22) relative to the connection body (15), wherein the at least one additional drive is a rotary or a translational drive.

5. The measurement device according to claim 4, wherein the at least one additional drive (33) is configured to move the probe tip (22) between a measurement position (M) for measurement of the object surface (13) and at least one additional position (R, K).

6. The measurement device according to claim 4, wherein the at least one additional drive (33) is configured to move the probe tip (22) between a measurement position (M) for measurement of the object surface (13) and a calibration position (K) and/or between the measurement position (M) and a rest position (R).

7. The measurement device according to claim 1, further comprising a protective enclosure (34) having an opening (35) through which the probe tip (22) projects out of the protective enclosure (34) at least when the probe tip is in a measurement position (M).

8. The measurement device according to claim 7, wherein the opening (35) of the protective enclosure (34) is configured to be opened and closed by a movable cover (36).

9. The measurement device according to claim 1, further comprising at least one support body (51) that abuts against the object surface (13) or an object holder (47) adjacent to a measurement location in an operation position (A) of the measurement device (10).

10. The measurement device according to claim 9, wherein the at least one support body (51) is elastically deformable.

11. The measurement device according to claim 9, further comprising a position sensor (52) that is communicatively connected with the measurement control unit (24) and that is configured to detect a reaching the operation position (A) relative to the object surface (13) and to provide a position signal (P) for the measurement control unit (24).

12. The measurement device according to claim 11, wherein the position sensor (52) is assigned to the at least one support body (51) and detects a force acting on the at least one support body (51).

13. The measurement device according to claim 11, wherein the measurement control unit (24) is configured to indicate the reaching the operation position (A) to the machine controller (27).

14. The measurement device according to claim 11, further comprising at least one additional drive (33) configured to move the probe tip (22) relative to the connection body (15), wherein the at least one additional drive is a rotary or a translational drive, wherein the measurement control unit (24) is configured to control the at least one additional drive (33) after reaching the operation position (A) in order to move the probe tip (22) into a measurement position (M) on the object surface (13).

15. The measurement device according to claim 1, further comprising a cleaning unit (53) that is configured to be controlled by the measurement control unit (24) and that is configured to clean a measurement location on the object surface (13) prior to measurement.

16. The measurement device according to claim 15, wherein the cleaning unit (53) comprises an electrically drivable fan and/or a fluid nozzle (54).

17. The measurement device according to claim 1, further comprising a damper (60), which is arranged between the connection body (15) and the probe tip (22) or the linear drive unit (23).

18. The measurement device according to claim 1, comprising a measurement standard (41) that is arranged on the support (16) for carrying out a calibration method.

19. A measurement system (42) comprising:
a measurement device (10) according to claim 1, and
an additional control (28),
the measurement system (42) being configured for use in the machine tool (12) comprising the machine side holder (11).

20. The measurement system according to claim 19, wherein the additional control (28) and the measurement control unit (24) cooperate in order to control a measurement progress.

21. The measurement system according to claim 19, further comprising a measurement standard (41) for carrying out a calibration method.

22. The measurement system according to claim 21, wherein the measurement standard (41) is configured to be releasably attached in an operation area of the machine tool (12).
